(19) United States
(12) Patent Application Publication
(10) Pub. No.: US 2011/0213622 A1
(43) Pub. Date: Sep. 1, 2011

(54) HEALTHCARE INFORMATION MANAGEMENT AND COMMUNICATIONS SYSTEM AND METHOD

(76) Inventor: Keith Berman, Westlake Village, CA (US)

(21) Appl. No.: 13/034,639

(22) Filed: Feb. 24, 2011

Related U.S. Application Data
(60) Provisional application No. 61/308,824, filed on Feb. 26, 2010.
(60) Provisional application No. 61/332,303, filed on May 7, 2010.

(51) Int. Cl. G06Q 50/00; G06Q 10/00

(52) U.S. Cl. 705/2

(57) ABSTRACT

An information and communications network for fulfilling information and communicating needs of health professionals is disclosed providing a system and method to provide an integrated record of patient-specific information and requests. According to one embodiment, this system and method includes first accessing patient-specific information and patient-specific requests via at least one portable electronic device (PED). Next, the system and method allows for updating or creating new patient-specific information and patient-specific requests via the PED. Subsequently, the system or method communicates via a network the patient-specific information and patient-specific requests to at least one server. Lastly, the system and method communicates via the network the patient-specific information and patient-specific requests to any additional PEDs and servers.

This application claims the benefit of provisional application Ser. No. 61/308,824 to Keith Berman, which was filed on Feb. 26, 2010, and provisional application Ser. No. 61/332,303 to Keith Berman, which was filed on May 7, 2010. The contents of 61/308,824 and 61/332,303 are incorporated entirely herein by reference.

### BACKGROUND OF THE INVENTION

1. Field of the Invention

The method and system of the present invention relates generally to the field of information management and communications systems, and more specifically to a system and method of providing, in the medical services field, patient-specific information over a network.

2. Description of the Related Art

Current medical information systems have only just begun to address the issue of utilizing existing electronic data communications technology to more efficiently and effectively bring the body of medical knowledge and skill to bear on the diagnosis and treatment of disease and illness. A major shortcoming in the related art is the failure to provide communications and information systems which satisfactorily addresses the need to correlate that vast body of medical knowledge in a manner that allows harnessing by medical personnel of that knowledge to resolve a patient's medical issues, especially in view of a complex and oftentimes uncoordinated system of medical insurance and prescription providers.

More particularly, a labor intensive approach has traditionally been taken to manage such information. During the care and treatment of a patient's medical condition, critical information must be gathered and organized from multiple sources. This information must be timely provided and equally as important, updated on a timely basis to reflect changes in the patient's condition. Furthermore, additional information related to the prescribed treatment plans including a pharmaceutical regime and laboratory procedures must be made readily available to the treating physician, or in not unusual circumstances to substitute medical professional who heretofore may rely on cryptic or incomplete notes and medical transcripts. Also, any proposed procedure or treatment may be required to be reviewed for approval by the patient's health care provider under the patient's health insurance policy before the procedure or treatment is followed.

In the latter situation, and according to the related art, the medical service provider generates a hard-copy request for a medical procedure which is then delivered to the requested service provider by the patient, a courier, or via facsimile or mail. The results are returned to the medical service provider in similar fashion, recorded on paperwork which must then be physically returned to the originating office. Before the requested medical service can be provided, the patient's medical insurance status must be confirmed. This further manual step conventionally requires that personnel working in a doctor's office or health care facility consult the latest revision of an insurer's printed “eligibility” list, or attempt to learn the status via telephone. Due to time constraints and overburdened medical office workers, this information may be delayed or incorrect when provided to the requestor. Oftentimes, incorrect or outdated information is generated by insurance company workers who must often determine or interpret specific restrictions in an individual policy.

Furthermore, in the “managed health care” operating environment favored by physicians who are members of treatment networks organized by private health insurers and the federal Medicare and Medicaid (PPO) and health maintenance organizations (HMOs), member doctors typically must request and receive authorization from a patient's insurer or HMO prior to performing a particular medical procedure or laboratory test, for example. The request for authorization and its subsequent approval or denial, are commonly handled with an exchange of paperwork, via the mail. Similarly, permission to refer a patient to another doctor is usually requested and received via mail or hand-delivered paperwork, again perpetuating the cycle of delays and possible inaccuracies in the information ultimately provided.

In an effort to manage this information flow, and according to the related art, virtually all medical services providers have begun to adopt some form of medical office management software for use with medical office computers for keeping track of patient information and medical histories, approved medications, insurance information, billing information, and other information critical to the maintenance of each patient's medical history. The related software products generally place such information into some form of a data record which is stored in one or more databases within a personal computer. It is known that such software products are uniquely configured by design to prevent conversion or prevent unapproved data migration into the database of another system.

Some medical offices have linked their computer systems to various insurance providers via a computer network for purposes of determining insurance eligibility, for example. However, as with the office management software products, most of the existing network systems are unique, with each system having its own set of system requirements, operating procedures, and communications protocols. Confidentiality is also a serious concern when using a network. Although some network-based systems encrypt the data sent over the network, the quality of the various encryption schemes and the procedures associated with them tend to vary widely. Also, many of these networks are arranged so that their user interface screens must be downloaded into the office computer over the network, which often results in long delays and poor responsiveness for the user due to the large amount of data that must be transferred over the network.

Yet, other third party venders and medical services suppliers may also need to communicate with the medical service provider but critical technical differences which exist between different platforms, systems and software adopted by the different providers tends to also provide a host of incompatibility, upgrading and training problems.

In addition, it is critical that such information be provided to the medical provider not only as quickly as possible, but in a format that the provider can easily and readily access. Furthermore, it is important that doctors are able to access this information while mobile as they consult with patients. To this end, the use of portable electronic or information devices has heretofore not met the challenge of integrating essential medical and patient specific information that is both readily usable but is also maintained in confidence as it is transmitted by electronic communications means.

Accordingly, there is a need for a system and method of readily establishing and dynamically updating all information related to a patient and timely and accurately providing that compiled information to the medical service provider on demand, and communicating further information to and from necessary third party providers in a seamless communications network, while maintaining that information in confidence.

### SUMMARY OF THE INVENTION

The present invention provides various embodiments of an information management and communication system and methods thereof. The different embodiments comprise various arrangements of such systems adapted particularly to the medical field. An object of the present invention is to provide to medical health care professionals direct access to patient information on a near real-time or real-time basis at the point of service.

A first method provides an integrated record of patient-specific information and requests, comprising: a) accessing patient-specific information and patient-specific requests via a portable electronic device (PED); b) further, updating or creating new patient-specific information and patient-specific requests via the PED; and c) communicating via a network the patient-specific information and patient-specific requests to at least one server; and communicating via the network the patient-specific information.

A system incorporating features of the present invention provides for managing healthcare information and requests comprising at least one PED having a data storage medium and a network communications interface. The system further includes at least one server having a network communications interface, a network over which the PED and the server can communicate; and the PED and the server capable of communicating patient information and procedure requests and results over the network.

Another embodiment provides a method for managing healthcare information and procedures comprising: a) providing a networked computer system comprising at least one portable electronic device (PED), server, and network communication interface; b) further, entering patient information or procedure requests into the PED; c) communicating via the network communication interface the patient information or procedure requests with at least one server; and d) communicating responses to these requests from a server via a network communication interface to a PED.

A better understanding of the features and advantages of the present embodiments will be obtained and apparent to those skilled in the art by reference to the following detailed description of the invention and accompanying drawings which set forth illustrative embodiments in which the principles of the invention are utilized.

### BRIEF DESCRIPTION OF THE DRAWINGS

FIG. 1 is a block diagram of an information management and communication system according to one embodiment of the present invention.

FIG. 2 is a block diagram of an information management and communication system according to another embodiment of the present invention.

FIG. 3 is a first block diagram of the system components of the system shown in FIGS. 1 and 2.

FIG. 4 is a second block diagram of the system components of the system shown in FIGS. 1 and 2.

FIG. 5 is a flow chart of the messaging process of one embodiment of the present invention.

FIG. 6 is a flow chart of the information importing process of one embodiment of the present invention.

### DETAILED DESCRIPTION

The present application provides systems and methods for automated networked service request and fulfillment systems to provide all patient-specific information in an integrated database accessible by a networked healthcare professional via an electronic device, preferably a mobile device or a portable electronic device (PED). Some examples of portable electronic devices or microcomputers include PDA's (personal digital assistant), smart phones, tablet computers, or other small or handheld computing devices which have networking capabilities, for use in a manner to be more fully described below. The systems and methods of the present application can provide complete patient examination, lab and drug history.

In accordance with the present invention, the process by which a patient disease is diagnosed and/or treated, in a healthcare facility or doctor's office, using electronic data communications is enhanced via the use of electronic data communications between the physician and one or more entities (also hereinafter referred to as “e-providers” and “e-partners”) which can contribute to the patient's diagnosis and/or treatment. E-providers and e-partners can include entities such as healthcare providers, insurance providers, labs, pharmacies, and other medical services entities. Such electronic data communications can include information that was previously received electronically from the patient and/or was developed as a consequence of a prior communication between the patient and the physician. The system of the present application creates an integrated suite of medical information and communication applications via a system of private communications networks using the internet and a locally available ISP (internet service provider) as a facilitator. The electronic data communications can be, for example, in the form of addressed messages, e.g., e-mail, or could be in the form of a direct data exchange between servers and clients or two endpoints, e.g., a physician inputting data during a query/response session from his/her PED or a computer keyboard directly into a remote computer system in which the physician has “logged in.” It is this information that is then communicated via the system of private networks, while gaining access to other private networks within the inventive system via the Internet.

Thus a physician or other medical services provider using electronic data communications in his/her practice may, in accordance with an aspect of the invention, use a PED (or handheld computer or handheld information appliance) to monitor and update a patient's medical history, download a patient's medical history from a legacy system during a medical appointment to obtain a history of treatment provided by other medical service providers, instruct a remotely-located medical diagnostic center, laboratory, or testing center to conduct a procedure such as performing prescribed tests, qualify eligibility for a proposed medical protocol by an insurance carrier, and to electronically message or receive a diagnosis, test results or any images that may have been created (such as an X-ray, MRI scan, CT scan, etc.) back to the medical services provider, to comprehensively establish a course of treatment selected in response to the various data, test results, insurance coverage and other inputs provided and supported by the system. For example, a physician could use the system to, while mobile, order a lab test and later review the results of this completed lab test.

A method and system of the present application further provides for on-demand data migration from prior art proprietary databases to the databases of the inventive system via a universal interface. The system employs a mapping system in which data from each medical service provider's database is inputted to a text file. The user maps and extracts data segregated by category to new data fields, whereby each update confirms existing patient-specific entries and adds new patient-specific information and data. Each PED is automatically and rapidly updated by uploading provided by the PC or server of changed, amended, or deleted information or data, in an encrypted, confidential format.

A method and system incorporating features of the present invention thus provides patient-specific information and implements fulfillment by a health-services provider of an approved medically-related service for use over a computer network. This is achieved by providing a networked information system having at least one portable information appliance such as a PED, used alone or in conjunction with a client-server link such as a PC having a data storage medium. A network communication interface is provided to enable communications including the flow of medical information, interpersonal communication information, and database information. In use, patient-specific information is entered into a PED by the health-services provider, and this information is communicated via the network communications interface to allied healthcare providers, insurance carriers and others joined in the network. With respect to third-party insures, and according to an aspect of the invention, health-services providers then implement a rules-based eligibility determination protocol after comparing the requested medical services protocol to the database. Acceptance of the request for service is communicated to the PED or other information appliance and updated to the data storage medium, over the networked information system. The system automatically updates the database with newly-inputted information and data without prompting, and such updates provided via Internet connection are automatically initiated, while using a locally available ISP, in a seamless and transparent information exchange among the various PED's, PCs, and databases networked within the system.

A method and system incorporating features of the present invention employs a client server, electronic communication architecture. A computer system (handheld or desktop), located at the point-of-care such as in the office of a professional such as a doctor or other medical services provider, supports a patient database. At the point-of-care there may be one or more PEDs. These PEDs can communicate directly with remote servers or through a PC which the PED may be connected to either wirelessly or directly. Regardless, of the method used to connect to servers, PEDs can also connect with PCs located at the point-of-care, wirelessly or by USB or other suitable connection, to interact with physician practice management systems. PEDs connected to PCs are configured to receive all database information from the client computer system, as well as updates on an automatic, real-time or near real-time basis. A near real-time basis would allow sufficient time to transfer data among the networks and networked electronic devices and storage mediums. Such information may be obtained either by automatic update or via interrogation of the database. Information inputted into a PED is up linked to the client computer system in a similar manner to update the client computer system regarding changed, added or deleted patient-specific information. Additional users of the system may include testing laboratories, providers of emergency transportation, third-party benefits payers, hospitals, and the like. A network-based mail server system utilizing a local ISP serves as the communications provider to implement and complete each communication.

The present method and system relies on the continued development of an information database including patient information, medical protocol information, eligible benefits that are patient-specific as provided by third-party payers, pharmaceutical and formularies information, and other medical services information necessary and desirable to establish a tightly-integrated medical services network.

Features of the present invention are described herein with reference to certain embodiments, but it is understood that the invention can be embodied in many different forms and should not be construed as limited to the embodiments set forth herein. In particular, the present invention is described below in regards to a networked system in different configurations, but it is understood that the present invention can be used in many other configurations. The servers and different components can have different capabilities, configurations, specifications, shapes and sizes beyond those shown and described and different numbers of servers and components can be used.

It is also understood that when an element such as a server, electronic device, hub server, computer, or other component is referred to as being “connected to” another element, it can be directly connected to the other element or intervening elements may also be present. Also, it may be connected either wirelessly or by a physical connection. Furthermore, relative terms such as “inner”, “outer”, “upper”, “above”, “lower”, “beneath”, “below”, “first”, and ‘second” and similar terms, may be used herein to describe a relationship of one layer or another region. It is understood that these terms are intended to encompass different orientations of the device in addition to the orientation depicted in the figures.

It is noted that the terms “server” and “servers” are used interchangeably throughout the application. A person of ordinary skill in the art will understand that a single “server” of the system may actually comprise several individual servers which are interconnected. Likewise, several “servers” may be considered functionally as a single server. Unless specifically stated otherwise, the Applicant does not intend to limit the scope of the invention as embodied in the claims by describing an element as comprising a “server” or “servers”.

Although the terms first, second, etc. may be used herein to describe various elements, components, regions, and/or sections, these elements, components, regions, and/or sections should not be limited by these terms. These terms are only used to distinguish one element, component, region, or section from another region, or section. Thus, a first element, component, region, or section discussed below could be termed a second element, component, region, or section without departing from the teachings of the present invention.

Embodiments of the invention are described herein with reference to illustrations that are schematic illustrations of embodiments of the invention. As such, the configurations can be different, and variations from the configurations and connections of the illustrations as a result, for example, different components are expected. Embodiments of the invention should not be construed as limited to the particular configurations or types illustrated herein but are to include deviations that result, for example, from manufacturing or vendors of system components. Furthermore, the shapes illustrated in the illustrations are schematic and representative of components and should not be considered as precisely setting out component features. Thus, the illustrations in the figures are schematic in nature and their shapes, sizes, or connections are not intended to limit the scope of the invention.

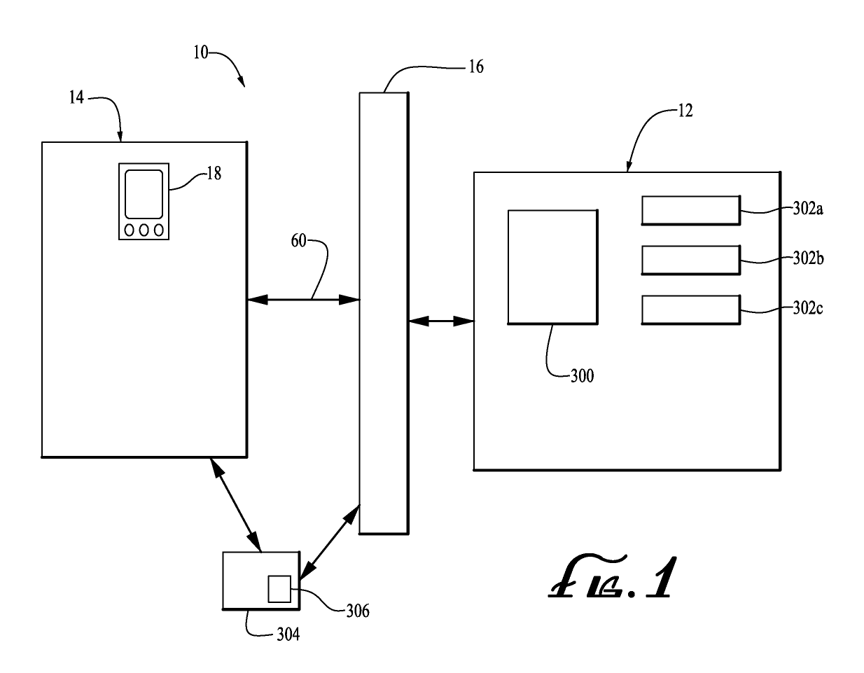

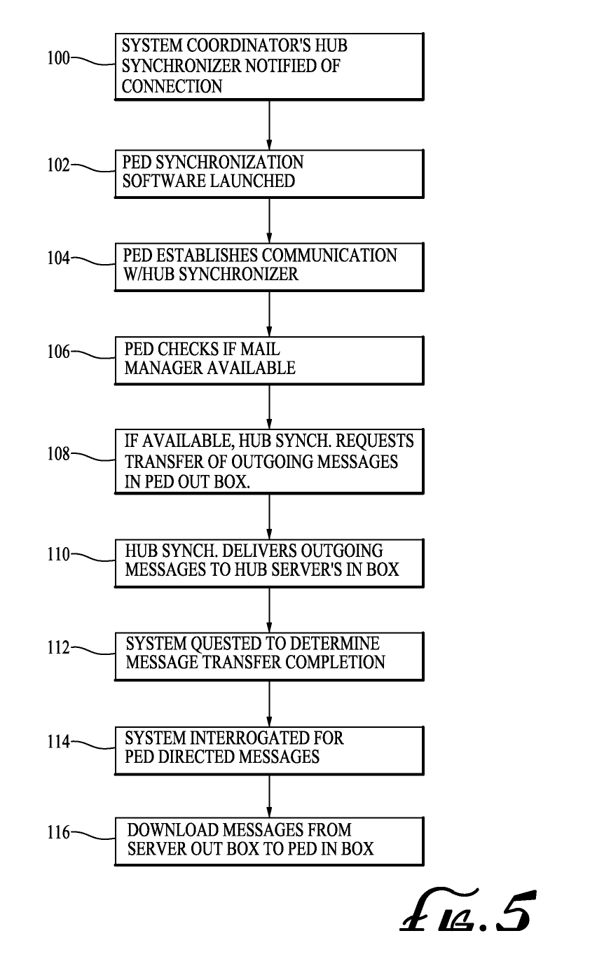

With reference now to the drawings, FIGS. 1-4 show a patient specific information and implementing system 10 according to one embodiment of the present invention. The system 10 includes a client system 12 hosting a remote server 300 and one or more hub servers 302a-c, and a server system 14 networked thereto via an interne connection such as an Internet source provider (ISP) 16. In some embodiments the remote server 300 serves to validate user log-ins from PEDs 18 and route PED information and requests to and from the hub servers 302a-c, maintaining a database only for record purposes. In other embodiments, remote server 300 may perform any additional functions described with reference to client system 12 described herein. Hub servers 302a-c may also perform any or all of these functions.

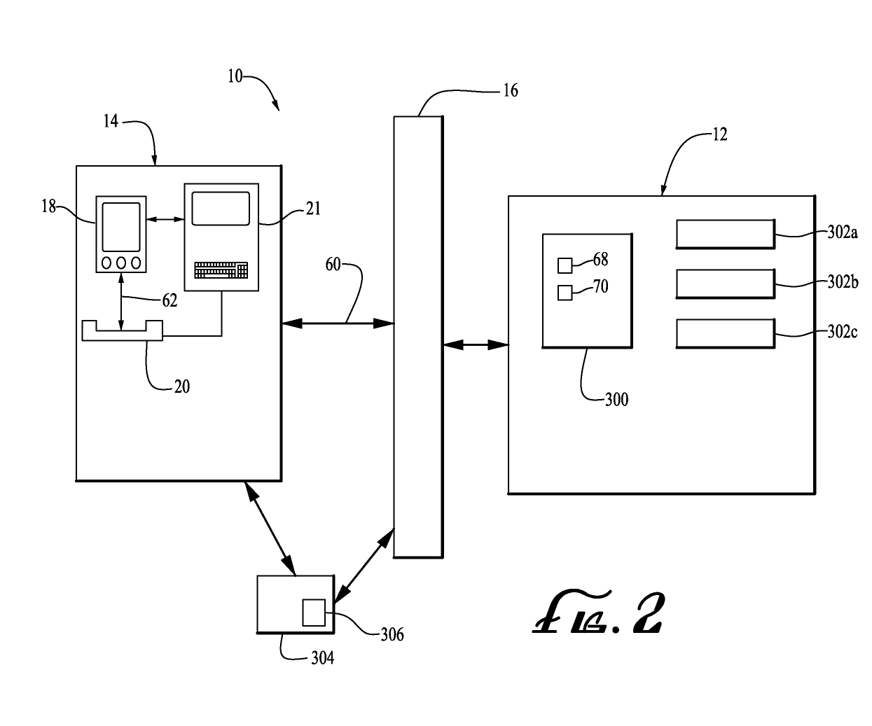

The networked server system 14 includes one or more handheld computers or handheld or portable personal information or electronic devices 18 (referred to as a portable electronic device or PED) such as microcomputers. Some examples of portable electronic devices or microcomputers include PDA's (personal digital assistant), smart phones, tablet computers, or other small or handheld computing devices which have networking capabilities, for use in the manner to be more fully described below. PED 18 also has data storage capabilities 30, such as a hard drive, however, any available data storage method is suitable such as a removable memory card or flash drive. The client system 12 communicates with each authorized PED 18 via the ISP 16, wherein the PED 18 connects to the ISP 16 via either an interconnected docking station 20 to a PC 21, as in FIG. 2, to perform data, communications and system uploads and downloads, as well as via a network communication interface 24 such as a wireless connection, utilizing a conventional modem 24 provided in the client system 12 and a modem 24 provided in the PED 18. The PED 18 may be connected to the ISP 16 directly or may be connected to a computer which is connected to an ISP 16. Information to be transmitted or received by each PED 18, remote server 300, or by a hub server 302a-c of the client system 12 is achieved by entering data into the PED 18 either directly by an input device or the screen itself, or indirectly by a display device 26 via a data entry device 28 of a personal computer (PC) networked therewith. Such information includes medical information, requests for information, interpersonal communication information, and database information, and is also uploadable to database 19 resident in PED 18. In embodiments where PED 18 is not connected to a PC, data may still be typed on a PC and imported to PED 18. Importing files and text may be done by any method known in the art such as electronically sending the file to the PED 18 (utilizing any file transfer method, such as e-mail), then using the systems file or text importing features or copy paste features to import the file or file's data.

More specifically, the display device 26 may be a monitor or projector, and data entry device 28 may be a touch screen or mouse and keyboard, for inputs to direct accessible data storage medium 30 local to the PED 18 or PC 21 connected to PED 18, such as a hard disc drive or removable storage media. Database 19 is stored on storage medium 30. In some embodiments, the database 19 is stored on a secured encrypted partition of storage medium 30 for added security. In these embodiments, if the PED 18 is stolen the data on the secured partition will be safe. Each PED 18 of the server system 14 runs an operating system (OS). The system of the present application may also function as the operating system on the PED 18, but can also run as an application running on the PED 18 in conjunction with another operating system already on the PED 18. The application running on said PED 18 to implement at least portions of said system may be developed in any programming language or development suite which is supported to run on the PED 18. One example is java, however any available development method and language is acceptable. Operating systems on the PED 18 may be any commercially available OS such as the Microsoft WINDOWS™ Mobile 6 operating system or other Microsoft OS, made by Microsoft Corp. of Redmond, Wash. Other suitable OSs include Android, Apple, Blackberry, and Linux based OSs. If PED 18 is connected to a PC each PC of the client system 12 may use any commercially available OS such as Microsoft WINDOWS™ 95, 98, 2000, NT, XP, Vista or 7 operating systems or any other OS such as those made by Apple or Linux.

In some embodiments, the PED 18 may function as a fat client or thick client. A thick client is a computer on a network which typically provides rich functionality independent of a central server. A thick client still requires at least periodic connection to a network or central server, but is often characterized by the ability to perform many functions without that connection. As a thick client, the PED 18 hosts the database of relevant information in its own data storage medium 30, thereby reducing the need to contact the client system 12 for any additional information. This can have advantages such as reduced need for internet connectivity, extended battery life since the network does not need to be frequently queried, and faster access to data since it is hosted locally. In other embodiments, the PED 18 may function as a thin client. A thin client describes a computer heavily dependent on a server's applications. A thin client generally does as little processing as possible and relies on accessing the server each time input data needs to be processed or validated. In these embodiments, the PED 18 would not host its own database but would rather contact client system 12 for all information. This can be advantageous since the system would not be constrained by the capabilities of the PEDs 18.

In some embodiments, important benefits of this system can include low bandwidth requirements using the File Transfer Protocol to transfer information, although the implementation of multimedia usage may beneficially enhance the operability of the system. The system is made user-friendly by employing a series of interactive selection, search, guidance and help screens that allow for self-contained intuitive and streamlined operation.

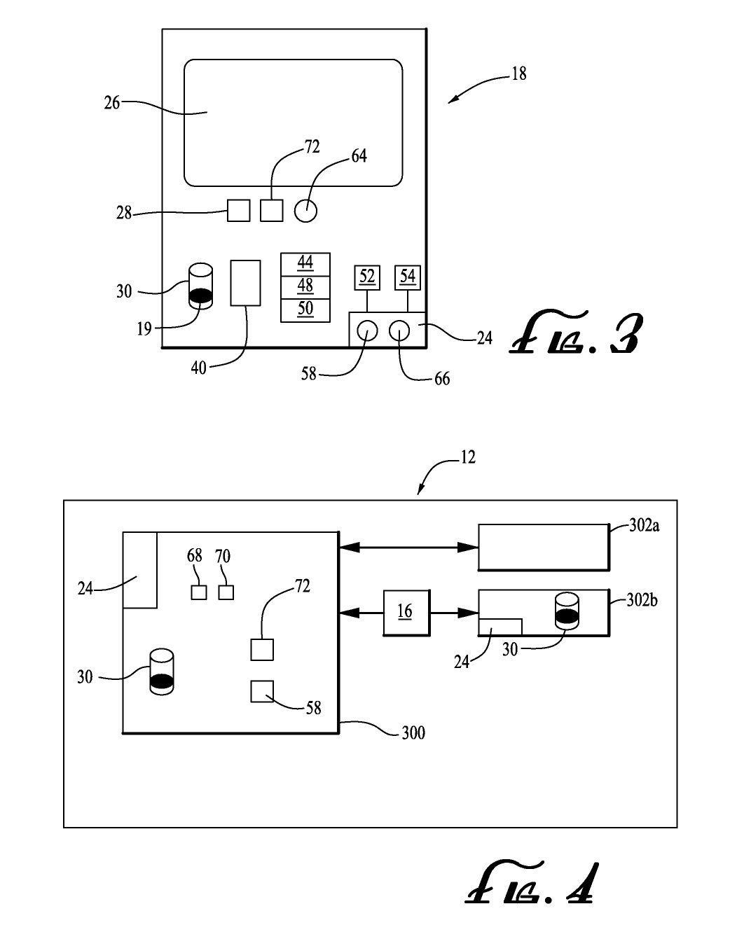

In embodiments where the PED 18 connects to an IS 16 via a PC 21, as shown in FIG. 2, rather than directly, a system coordinator 40 coordinates data, communications and other information flow via networked system 10. Specifically, the system coordinator 40 initiates data synchronization between the hub server and the PED 18, desktop message processing, as well as the Internet transfer program. In one embodiment, the system coordinator may function as follows: The system coordinator responds to input from a user communicating with the hub server via an interface which may be a graphical user interface or via a user-programmed scheduler or screen saver 44 working in the background. The scheduler 44 reads, to a database 19 via a database manager 48, and communications to be uploaded to a PED 18 or even another hub server are transferred via a message transfer manager 50 that oversees operation of in box 52 and out box 54. In embodiments where the PED 18 connects to an ISP 16 directly, rather than through a PC, the system coordinator 40 and related systems reside in or are handled within the PED 18 (in FIG. 3 system coordinator 40 is shown in the PED, not PC, but may exist in either). The components discussed herein, such as a system coordinator 40, a scheduler 44, a database manager 48, a message transfer manager, an in box 52, an out box 54, and other components discussed below, may exist independently but may also exist within the storage medium 30 as software components.

Connectivity is obtained between the client system 12 and the PED 18 via either of at least two ways. First, the PED 18 may wirelessly interface with the client system 12, via an ISP. This may be done in one embodiment as follows. The PED 18, via an onboard PED link 24 is wirelessly interfaced with a PED connection manager 58 resident in the client system 12, via the ISP 16, the wireless interconnection being shown by link-60. Secondly, the PED 18 may connect wirelessly or via a hard link in the docking station 20 to the PC 21, which is connected to client system 12 via an ISP. This may be done in one embodiment as follows: The PED 18 is interfaced with the client server 12 via a hard link 62 via the docking station 20 in which the PED 18 is received. A database manager 64 also resident in PED controls software and database operations as the skilled artisan in the related art will appreciate, employing the requisite software 66, to facilitate wired or wireless communications between the PED 18 and a hub server of the client system 12. The PED link 24 further reads to in box 52 and out box 54 in the manner to be further described below.

More specifically, each PED 18 is assigned a unique identifier read into a PED registry 72 resident in the PED 18 or on the client server 12. Messages are sent and received between an individual PED 18 and remote server 300 or a hub server 302a-c, after confirmation is received confirming the designated identifier coupled with known password control. In some embodiments users can log into the system on the PED 18 with a username and password. These can be authenticated either on the PED or client server 12 using known authentication methods. The use of usernames and passwords allows different users to use the same PED 18. Such controlled messaging has significant importance to the operation of system 10. According to the system, inputs or updates on the PED 18 can be sent back to the client server 12 updating the remote server and hub servers. These updates can in turn be sent to all PEDs 18 updating them. In one embodiment such updates can be accomplished as follows: messages are relayed (transmit/receive) from the PED 18 via any available local ISP 16 to an in box 52 of the remote server 300 or a hub server 302a-c, as shown in FIGS. 1, 2, and 4. More specifically, following transmission from the PED 18, new messages are received by an in box 52, to be broadcast to and subsequently retrieved by all of the hub servers 302a-c, thereby enabling all hub servers to be uniformly updated. In the context of the present invention, it is this uniform updating that provides near real-time and, uniform dissemination of patient-specific information to all medical services providers who are qualified to and eligible to receive such information. It will be noted that incoming messages brokered by the ISP are transmitted to the remote server 300 or hub servers 302a-c, and local database updates are read to the database 19 (FIGS. 1-4), or the hub servers 302a-c may have a local database to which such updates may be read. The figures show 2-3 hub servers; however any number of hub servers may be present. Further, PEDs 18 may communicate to each other the same way they communicate to the servers.

With reference to FIG. 1-4, a message received through an Internet connection is logged in by the system coordinator on the server 14, and is further decompressed and validated. The message is further decrypted according to the encryption/decryption protocol described below, and the message is then uploaded to the PC or PED to update the relevant patient-specific file. When the message is received by a PED, the updated file may be provided in a compressed or date-compressed format.

Specifically, a message relayed by packet stream includes an identifier encrypted in a first code at a transmitting end (either the PC or PED), and the packet is segmented into a plurality of segments with each segment being encoded and compressed with check digits. The segments are then transmitted through a message parser via separate Internet communications channels and reassembled at a receiving end (either the PED or PC without limitation). According to one embodiment of this inventive protocol, the packet is preferably trifurcated into three segments including header, body and footer segments, although further segmentation for additional levels of secure transmission is contemplated by the inventors. Thus, a message may be segmented into as many segments as Internet communication channels are available or as desirable to further enhance secured message transmission using this encryption protocol. It will also be appreciated that the check digits block transmission of the associated compressed segment, adding yet an additional security element.

Further, messages may be encrypted by any known encryption method such as 128-bit encryption protection. In one embodiment, messages or other information being sent are first converted to an unreadable format such as an image. Any suitable image file type may be used, including but not limited to bitmap, jpeg, gif or tiff image file types. Next, the image is segmented as described herein, encrypted and sent. Once the information is received and assembled, it is decrypted and the image is converted back to data. This allows an extra layer of protection for the sensitive information being transferred on this system because even if the encryption is compromised and deciphered, those intercepting the information would only be able to assemble an image and not the date itself.

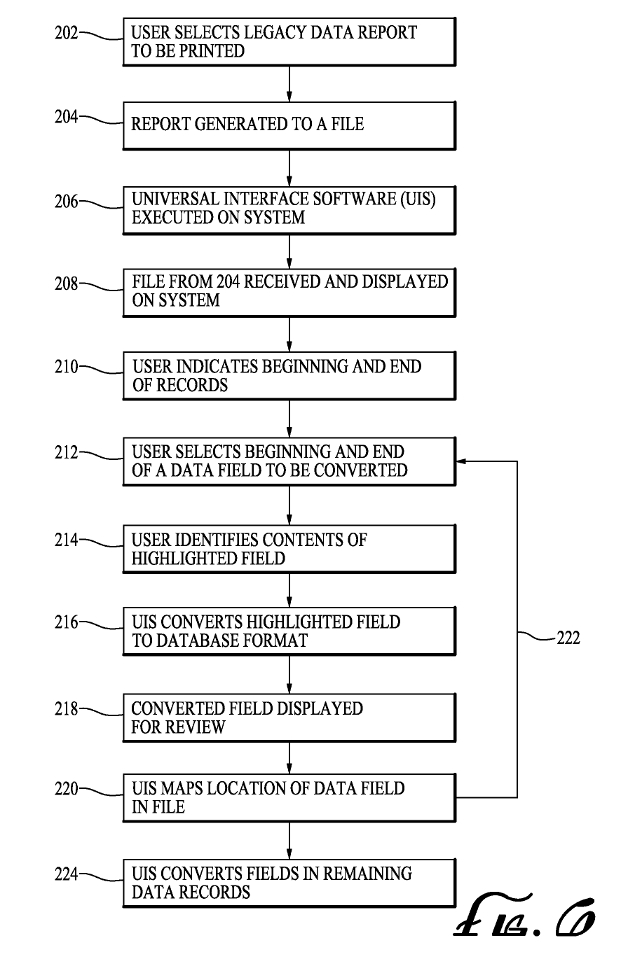

As shown in FIG. 5, one embodiment of how messaging may be completed is as follows; however, other methods may be used according to the above. Accordingly, in a first step (step 100) complete messaging is achieved when the system coordinator's hub synchronizer is notified of the newly formed connection and launches, in a second step (step 102) corresponding PED synchronization software via the PED link 56. The PED 18 through its synchronization software then establishes communications with the hub synchronizer (step 104) and checks if a mail transport manager resident on the client server 10 is available for use (step 106). If so, the hub synchronizer requests transfer of all outgoing messages resident in the PED's out box 70 (step 108) and delivers them to the hub server's in box 52 (step 110). The system is further queried to determine if message transfer has been completed (step 112). The system is interrogated for PED-directed incoming messages (step 114), and provides message downloading from the hub server's out box 54 to the PED's in box 68 (step 116).

The system rapidly and efficiently works with legacy systems of the prior art, wherein a legacy system is typically a computer system that a medical services provider had used prior to adopting the system and method of the present invention. The system can interact in many ways with legacy systems. One way may include hub servers or client server applications tailored to communicate or interact with the client server and the PEDs 18. In another embodiment, to transfer the data records stored in a first format in any such legacy database into data records stored in the format and the database 30 used by the client server 12, a user first executes the application program associated with the legacy database. Although there are many different database application programs in use, which use many different formats, one function common to nearly all such database programs is the ability to print out reports, such as a patient roster or a list of insurance providers. Then this report is parsed by the system, importing the related data and records. As shown in FIG. 6, as a means of accessing a group of legacy data records, the user selects one of these reports to be printed (step 202). A report is then generated (step 204) which includes the database records to be transferred, to be written to a file rather than printed.

In a next step (step 206) the universal interface software is executed on the system to which the legacy database records are to be transferred, which is typically the client server 12 but can also be a hub server or the PED 18 itself. The file written at step 204 is retrieved by the software (step 208) and the contents displayed on the display device 26. As displayed, the file is likely to include a header and footer, with a number of data records between the header and footer. Each data record typically includes printer control characters, data labels and delimiters. Each record will also include “data fields”, which contain information such as a patient's name, ID number, birth date, sex, etc. It is the data fields from each data record in the file which are to be transferred into the new database.

The user indicates the beginning of the first record to be transferred and the end of the last record to be transferred, using the mouse, for example, to define for the software the area in which the data of interest is confined (step 210).

The user then selects a data field to convert from within a selected data record, preferably the first data field of the first data record, and indicates the beginning and end of the selected field (step 212). As implemented, this is done by “highlighting” the data field by dragging the mouse cursor across it. The contents of the highlighted field are then identified (step 214). A list of possible identifiers is presented, including labels such as “Patient ID”, “Name”, “Date of Birth”, and “Sex”, and the user selects the entry on the list that describes the highlighted field.

Now that the selected data field's text has been highlighted and identified with a particular label, the software converts the highlighted field into the database format used by the client server (step 216), which can be any of a number of user-determined formats as will be appreciated by the skilled artisan. The converted data field is displayed for review to verify that the field was correctly converted (step 218).

The software maps the location of the data field just converted, by noting, for example, its position in relation to the beginning of the selected record, and the characters which precede and follow the field, (step 220).

If there are more data fields to be converted in the selected record, the software branches (step 222) back to step 212 and another data field is highlighted. Steps 212, 214, 216, 218 and 220 are repeated until all the data fields of interest in the selected record have been converted, displayed, reviewed and mapped. If there are data fields in the selected record which are not needed in the new database, they are simply ignored during this sequence of steps.

When all data fields of interest in the selected record have been processed as discussed above, the program flow moves to the next step in which the software automatically converts the data fields of interest in all the remaining data records in the file to the format required by the client software database (step 224). The information regarding the start and end of the data records in the file defined at step 210, and the description and location of each data field within a record identified and mapped at steps 214 and 220, respectively is used by the software to properly locate and convert the data fields of interest in each of the remaining data records, without user intervention. The converted data fields from each of the file's data records are then stored into the database used by the client server software (step 226).

The file created at step 204 may contain hundreds or thousands of data records. Because all but one record are converted automatically, a significant time and cost savings results from using the universal interface software to establish the new database needed by the client server 12. The sequence of steps described above is repeated for each of the legacy database reports which contain data needed by the client server, and may include reports for virtually any medical or health care service provider maintaining patient-specific records.

The universal interface software can be used effectively with virtually any legacy database. Because the user defines the location of the data fields for the software, the method works regardless of the particular spacing and delimiters employed by the legacy database.

Information stored on PCs 304, such as those previously used in healthcare offices to store the daily patient schedule or patient files or those hosting physician practice management software, which PEDs 18 interact with directly may also transfer information in at least the ways described above. Furthermore, the system may be tailored to interact with legacy systems and physician practice management software 306 directly and in real-time. Both updating information and downloading information from these systems or software to PEDs. This can be achieved by using software tools written to directly interact with these systems or software. Those skilled in the art would recognize how to structure software to interact with other industry software.

It is a further object of the present invention to confirm proposed medical treatments via direct e-communications access to a medical guidelines protocol. In use, patient-specific information is entered into a PED 18 by the health services provider, and this information is communicated via the system 10 to allied healthcare providers, insurance carriers and others joined in the network. Health service providers may include doctors, nurses, surgeons, receptionists, and others who provide health services. Healthcare providers may include hospitals, insurers, labs, pharmacies, and other healthcare providing units. With respect to third-party insurers, and according to an important aspect of the invention, health-services providers then implement a rules-based eligibility determination protocol after comparing the requested medical services protocol to the database of the same. Acceptance of the request for service is communicated to the PED or other information appliance and updated to the data storage medium, over the networked information system. The system automatically updates the database with newly-inputted information and data without prompting, and such updates provided via Internet connection are automatically initiated, while using a locally available ISP, in a seamless and transparent information exchange among the various PED's, PCs, and databases networked within the system. This allows for PED users to input a requested treatment or other request and receive instant approval or denial from healthcare providers, insurers, or their decision protocols.

The system or method of the present application also provides such information including patient medication and drug data updated on an automatic basis to enable all health care professionals' current and immediate patient-specific information. The method or system of the present application also may centralize formulary and prescription medicine data. Using the PEDs 18 healthcare professionals can request prescriptions and the system will use patient information to determine drug interactions. If none exist or the healthcare professional overrides these, the prescription can be sent to a pharmacy for filling, directly from the PED 18. Healthcare professionals may also use the system on the PED 18 as a reference guide since the database would include desk reference guides. The system can also be used to bill, to patients or healthcare providers or insurers, all procedures performed by the healthcare professional, since the system can be pre-programmed to include all billing codes and can electronically submit these to the providers or insurers. Furthermore, healthcare professionals, providers, and insurers can use the system, which functions as a centralized compendium of patient information, to print full and complete patient charts by printing the information, or exporting it, to a printer.

Exemplary operation of one embodiment of the system via each PED is as follows. After logging onto a password protected PED, a menu is presented containing various user selectable options. These options include, but are not limited to, accessing, submitting, and/or entering patient information, patient schedule, prescription information, medical protocol information, insurance information, care management information, diagnosis information, billing, charts, outpatient medical procedures such as laboratory test orders and patient appointment information. It will be appreciated that the system enables return and receipt of outcomes and results to be entered in the appropriate PED and/or PC database. Options also include access to medical guidelines information, prescription drugs information databases, and other related databases and services.

Typically, the system is accessed via one or more functions or modules. One module is for “Patient Identification”, for receiving such information by inputting demographic, address and telephone number information. Another module is a “Patient Roster” into which patient-specific diagnosis and procedural history (past and proposed) is entered. The system further includes an “Insurance” module for recording patient-specific insurance information. Additionally, a “Menu” module contains advanced patient-specific information including applications for recording, for example, prescription histories, laboratory test order histories, and medical treatment histories. A billing module, known as SUPERBILL™ receives posts and generates invoices and encounter reports on a patient-specific basis.

More specifically, following access through the patient identification module, the Patient Roster screen lists the selected patient's name, treating physician, facility/room and company name. Individual screen buttons may be labeled for access to more detailed patient identification, care management, insurance information, episode information, and menu information. A subsequent screen listing Roster Data lists patient identification and demographic information. Insurance information may include inputs for primary and secondary insurance information. A Care Management screen is divided into a plurality of sub-screens including CPT codes and descriptions. CPT codes are procedure or diagnosis codes used in the state of California. Other codes for other practice areas may also be shown such as ICD9, used in hospitals, and HCPCS, which are the codes used in other states. The Care Management screen further includes a diagnosis and discharge information (Dx/Proj. DC) screen, providing for input of the required medical care level (acute, subacute, rehab, obser, ED, other). The Diagnosis screen allows for the selection of a diagnosis code and description (“Protocol Dx”), and presents available diagnoses in dropdown screen. Acceptance of an enumerated diagnosis may be made by clicking on an ACCEPT button, or cancellation may be achieved by clicking on a CANCEL button.

For diagnosis that may not have a protocol, the PED user clicks on ALL Dx which opens a “Select Diagnosis” screen containing a list of diagnoses by medically-related group. Highlighting of the appropriate group now provides access to a list of individual disease codes from which a sub code may be selected, breaking the diagnosis down further into a concise list of possible diagnoses.

Further selection of the appropriate diagnosis yields a protocol screen listing various options, such as “Response Required”, “Etiology/Admit?”, “DifferentialDx”, “Test/Procedures”, “Consultations”, “Medications”, and “LOS Goal Guide”. A “Pre Tag” screen is provided to assign tasks to dates for completion. The “Response Required” screen is so indicated by an “R” icon presented in a linked screen (procedure, medication, etc.), and the appropriate response selected from the group including “Done”, “Not Done”, “Physician Discretion”, and “Contraindicated” may be entered to answer the protocol. Response required tasks refer to tasks which must be completed in a certain time frame and not repeated. This prevents duplicated efforts which can be both costly and dangerous. If the user selects Contraindicated, a reason must be entered into the provided description field. Further, a reason must be selected from a contraindication code/description dropdown box.

The Etiology/Admit screen provides what type of criteria is needed for a hospital admission, such as infectious criteria. System-defined adequate and inadequate criteria utilizing the current diagnosis are provided. In addition, alternatives to admission lists alternative interventions for treatment in place of hospital admission. To this end, an admission algorithm may be provided that differentiates conditions for admission. The admission algorithm utilizes inputs including patient characteristics, illness, physical examination findings, and laboratory findings to determine a risk result, or necessity of admitting a patient.

The Differential Dx option lists all possible diagnosis based on a current condition. This is based on inputs such as patient information, vitals and symptoms. Using this information the system may calculate a list of possible diagnoses and the probability or likelihood of this diagnosis being correct based on the information provided. This probability is calculated not only based on the matched symptoms but also using game theory which weighs different sources of information, such as doctors' opinions and practice guides reviewed by many doctors, based on their credibility.

The Test/Procedures option provides an explanation of what work needs to be done within a specific time frame based on a diagnosis or several diagnoses. The Consultations screen lists consultations needed for the particular diagnosis. The Medications screen lists what medicines are to be prescribed based on the assigned diagnosis.

The length of stay (LOS) Goal Guide can help physicians determine, based on the specified condition of the patient, the length of the patient's stay in the hospital based on the expectations of managed health care organizations. Discharge data may include projected discharge data, as well as including a reason for changing this date selectable from a dropdown box. An ABD/C8 (avoidable bed days/critical reasons) screen allows for entry of information concerning discharge by a patient either earlier than projected, or longer than scheduled. In particular, a critical reasons code and description section allows for recording of health problems that are urgent and could delay release. A Rehos/HR screen allows for recording a patient's risk to be re-hospitalized, including reasons noted by a High Risk Predication Code and note provided in dropdown screen format. A step therapy screen may also be provided which sets out predefined steps for treatment of a patient or patient's condition. These predefined steps may be provided in a decision tree format or other format conducive to treatment steps.

It will be further appreciated that the present application's method of determining eligibility of a prescribed medical service provides real-time or near real-time response following database interrogation, and enables the medical services provider to simultaneously verify provided approved services, cross-check against medical histories, cross-check against possible formulary interactions also programmed into the PED-accessible database, and post the attendant billing information, thereby significantly reducing and in many instances overcoming the related art problems of delay and undue paperwork transmission.

The prescription function of the system and method of the invention allows the health care professional to prescribe a drug for the patient, check for possible known drug interactions against medications contained in the patient's medical history, check for therapeutic duplicates and verify formulary compliance. The PED user may also access Rx information by clicking on a PDR (Palmtop Drug Reference) button and may search by drug name or drug class. Upon selecting the drug from the dropdown screen, information including warnings, indications and usage are presented. A prescription may be created and sent to a pharmacy utilizing the e-Rx Function screen, in some embodiments utilizing a search algorithm. A generic form of the Rx may also be queried. A Quick List may also be referenced for drugs that are more frequently prescribed.

In either case, information on brand/generic names, the designated route for ingestion, strength ordered, form of the drug, quantity, day supply, refills and any comments may be inputted in the appropriate cell to define the parameters of the prescription. When completed a drug interactions check may be run, and if appropriate, an interaction report will be generated. As an additional aspect of the present application, the medical services provider may utilize a ratio or calculations option or pharmaceutical calculator, to calculate a drug dosage, inputting formulae selected from a dropdown screen, inputting variables where indicated and calculating a dosage. This calculator includes formulas related to biochemical problems.

The system and method of the application also would allow for the reference of the full allergy history of patient. This information would then be incorporated into drug interaction decisions and treatment or diagnosis recommendations.

The method and system of the application further enables for prompt or automatic authorization of medically necessary procedures, tests, and prescriptions by communicating these requests and results via the network or ISP or referencing protocols within the database, as described above. Automatically updated information regarding patient and primary and secondary insurance policies insures up-to-date information is available to the health care provider within the constraints of the particular policy, by updating the PEDs of the system as that information becomes available from the relevant insurance company(s) or other healthcare partners. Authorization is then electronically received from the insurance company for a medical procedure or other requests, thereby helping eliminate the time-consuming, error-prone paper-based practices of the prior art.

As described above, the medical service provider inputs patient-specific data and either updates that data or processes any related service request by performing the requested service, and the results of the processing, consisting in the above examples of the test results, the authorization decision or eligibility status, or the pre-admission confirmation, are received by the client system 12 and formatted into a fulfilled service request message which is electronically sent back to the original requester.

A legacy system is typically the computer system a service provider had used prior to procuring the present invention. The service provider's personnel interact with the legacy system, with the client system 12 generally operating automatically and without intervention. Service request messages received by the client system 12 are automatically transferred to the legacy system for processing by the service provider: The necessary work is performed, for example: a patient's blood test is run, a decision is made regarding the authorization of a requested medical procedure, etc., and the results of the work are entered into the legacy system. The client system 12 automatically retrieves results from the legacy system, assembles a fulfilled service request message, and electronically sends the fulfilled service request message back to the requesting client system 12.

The automated networked service request and fulfillment system described herein also includes “universal interface” software, typically stored on the client system's data storage medium 30 (identified in FIGS. 1-4), which provides a solution to the problems encountered as a result of the myriad of database record formats presently in use in professional offices. In the past, converting these existing, “legacy” database records into the record and database format used by a new office management software package required hours of manual data re-entering. As described above, the universal interface program provides an automated method of importing the legacy data records, converting them into the record format used and needed by the client software, and storing the converted records into a new database. This process normally need only be performed once, when the automated networked service' request and fulfillment system is first incorporated into an office. Once all the legacy records have been converted and stored into a new database, all new records are entered directly into the new database.

The system of the present application may be administered on PEDs running two or more different versions of the software. In one embodiment the software on the PEDs has two versions. One version is tuned for use with outpatients and another tuned for hospital care. Each version would include at least a subset of the features described above which are applicable to either outpatient or hospital care. For example a version for outpatient care would allow access to patient information, details, insurance, new condition entry, treatment protocols and steps, and diagnosis and prescription information. A hospital version would include features such as patient information, details, insurance, LOS guides, accident report forms, and an emergency response module providing treatment suggestions based on provided emergency symptoms.

While particular embodiments of the invention have been shown and described, numerous variations and alternate embodiments will occur to those skilled in the art based on the teachings herein. Accordingly, it is intended that the invention be limited only in terms of the appended claims.

I claim:

1. A method to provide an integrated record of patient-specific information and requests, comprising:
accessing patient-specific information and patient-specific requests via at least one portable electronic device (PED);
updating or creating new patient-specific information and patient-specific requests via said PED;
communicating via a network said patient-specific information and patient-specific requests to at least one server; and
communicating via said network said patient-specific information and patient-specific requests to any additional PEDs and servers.

2. The method of claim 1 wherein said patient-specific information comprises patient personal information, patient symptoms, patient diagnosis, and patient insurance information.

3. The method of claim 1 wherein said patient-specific request comprises an order for a medical test to be performed on a patient.

4. The method of claim 1 wherein said patient-specific request comprises a request for the authorization of a medical procedure by a patient's medical insurance company.

5. The method of claim 1 wherein said patient-specific request comprises a request to verify the medical insurance coverage of a patient.

6. The method of claim 1 wherein said patient-specific request comprises a prescription for a pharmaceutical.

7. The method of claim 1 further comprising updating said at least one server and said at least one PED with fulfilled patient-specific request.

8. The method of claim 7 wherein said fulfilled patient-specific request comprises results of a medical test performed on a patient.

9. The method of claim 7 wherein said fulfilled patient-specific request comprises a result of the request of authorization of a medical procedure by a patient's medical insurance company.

10. The method of claim 7 wherein said fulfilled patient-specific request comprises a result of a request to verify the medical insurance coverage of a patient.

11. The method of claim 1 further comprising importing patient-specific information from a legacy system to said at least one PED.

12. The method of claim 1 further comprising importing patient-specific requests from a legacy system to said at least one PED.

13. The method of claim 1 further comprising importing patient-specific information from a legacy system to said at least one server.

14. The method of claim 1 further comprising importing patient-specific requests from a legacy system to said at least one server.

15. The method of claim 1 further comprising including a diagnosis reference guide on said PED.

16. The method of claim 1 further comprising including a pharmaceutical reference guide on said PED.

17. The method of claim 1 further comprising including a length of stay reference guide on said PED.

18. The method of claim 1 further comprising including patient eligibility protocols on said PED.

19. The method of claim 1 further comprising including a step treatment guide on said PED.

20. The method of claim 7 further comprising encrypting an at least one outgoing patient-specific information and patient-specific request when communicated via the computer network, and decrypting an at least one incoming patient-specific information, patient-specific request, and fulfilled patient-specific request.

21. The method of claim 18 further comprising determining patient eligibility for patient-specific requests by comparing said patient-specific requests to said patient eligibility protocols.

22. The method of claim 1 wherein said network is the internet.

23. The method of claim 1 wherein said network is a private network.

24. The method of claim 1 wherein said network is a public network.

25. The method of claim 1 further comprising saving said patient-specific information and patient-specific requests to a data storage medium.

26. The method of claim 7 further comprising communicating said patient-specific information, patient-specific request, and fulfilled patient-specific requests on at least a near real-time basis.

27. The method of claim 1 further comprising validating the user of said at least one PED by comparing said user's information to information on said at least one server.

28. A system for managing healthcare information and requests comprising:
at least one PED having a data storage medium and a network communications interface;
at least one server having a network communications interface;
a network over which said at least one PED and said at least one server can communicate; and
said at least one PED and said at least one server capable of communicating patient information and procedure requests and results over said network.

29. The system of claim 28 wherein said network communication interface connects to said network via a physical connection.

30. The system of claim 28 wherein said network communication interface connects to said network via a wireless connection.

31. The system of claim 28 wherein said network communication interface connects to said network via an ISP.

32. The system of claim 28 wherein said server further comprises a data storage medium.

33. The system of claim 28 wherein said PED further comprises a display device and a data entry device.

34. The system of claim 33 wherein said PED is capable of accepting data entered to said PED via said data entry device and saving said data to said data storage medium.

35. The system of claim 34 wherein said data is transferred via said network to said at least one server.

36. The system of claim 35 wherein said server updates said data on all PEDs.

37. The system of claim 32 further comprising rules based protocols, which determine patient eligibility for procedures, stored on said data storage medium of either said at least one server or said at least one PED.

38. The system of claim 32 further comprising patient information stored on said data storage medium of either said at least one server or said at least one PED.

39. The system of claim 32 further comprising a medical reference guide stored on said data storage medium of either said at least one server or said at least one PED.

40. The system of claim 32 further comprising a pharmaceutical reference guide stored on said data storage medium of either said at least one server or said at least one PED.

41. The system of claim 32 further comprising a billing codes and reference guide stored on said data storage medium of either said at least one server or said at least one PED.

42. The system of claim 32 further comprising a diagnosis determination application stored on said data storage medium of either said at least one server or said at least one PED, capable of determining a patient's diagnosis based on said patient information.

43. The system of claim 28 wherein said patient information comprises any of patient personal information, patient symptoms, patient diagnosis, and patient insurance information.

44. The system of claim 28 further comprising 3^{rd} party systems capable of receiving, processing, and responding to procedure requests.

45. The system of claim 44 wherein said 3^{rd} party systems corresponds to a lab.

46. The system of claim 44 wherein said 3^{rd} party systems corresponds to a pharmacy.

47. The system of claim 44 wherein said 3^{rd} party systems corresponds to a any medical testing facility.

48. The system of claim 32 wherein said patient information is updated on said data storage medium in real-time.

49. The system of claim 28 wherein said network is the internet.

50. The system of claim 28 wherein said network is a private network.

51. The system of claim 28 wherein said network is a public network.

52. The system of claim 28, further comprising means for comparing via the network communications interface said patient information with allied healthcare providers to determine eligibility of a prescribed medical service.

53. The system of claim 28, further comprising means for encrypting each outgoing communication on said network, and decrypting each incoming communication.

54. The system of claim 28 wherein said patient information comprises patient personal information, patient symptoms, patient diagnosis, and patient insurance information.

55. The system of claim 28 wherein said procedure request comprises an order for a medical test to be performed on a patient.

56. The system of claim 28 wherein said procedure request comprises a request for the authorization of a medical procedure by a patient's medical insurance company.

57. The system of claim 28 wherein said procedure request comprises a request to verify the medical insurance coverage of a patient.

58. The system of claim 28 wherein said procedure request comprises a prescription for a pharmaceutical.

59. The system of claim 28 further comprising said at least one server and said at least one PED capable of communicating fulfilled procedure request.

60. The system of claim 59 wherein said fulfilled procedure request comprises results of a medical test performed on a patient.

61. The system of claim 59 wherein said fulfilled procedure request comprises a result of the request of authorization of a medical procedure by a patient's medical insurance company.

62. The system of claim 59 wherein said fulfilled procedure request comprises a result of a request to verify the medical insurance coverage of a patient.

63. The system of claim 28, wherein said procedure request comprises an order for a medical test to be performed on a patient.

64. The system of claim 28, wherein said procedure request comprises a request for the authorization of a medical procedure by a patient's medical insurance company.

65. The system of claim 28, wherein said procedure request comprises a request to verify the medical insurance coverage of a patient.

66. The system of claim 59, wherein said fulfilled procedure request comprises the results of a medical test ordered with a corresponding service request message.

67. The system of claim 28, wherein said at least one PED is capable of importing patient information from a legacy system.

68. The system of claim 28, wherein said at least one PED is capable of importing patient requests from a legacy system.

69. The system of claim 59, wherein said at least one PED is capable of importing fulfilled patient requests from a legacy system.

70. The system of claim 28 wherein said at least one PED is accessed with the use of a username and password.

71. The system of claim 28 wherein at least a portion of said data storage medium is secured by encryption.

72. A method for managing healthcare information and procedures comprising:
providing a networked computer system comprising at least one portable electronic device (PED), server, and network communication interface;
entering patient information or procedure requests into said at least one PED;
communicating via said network communication interface said patient information or procedure requests with said at least one server; and
communicating responses to said requests from said at least one server via said network communication interface to said at least one PED.

73. The method of claim 72 wherein said at least one PED comprises a data entry device, display device, and data storage medium.

74. The method of claim 73 further comprising updating said at least one PED with information from said at least one server via said network communication interface.

75. The method of claim 74 wherein said updating of said at least one PED further comprises saving said updates to said data storage medium.

76. The method of claim 73 wherein entered patent information and procedure requests are saved to said data storage medium.

77. The method of claim 73 wherein said data storage medium is secured by encryption.

78. The method of claim 72 further comprising encrypting outgoing communication via said network communication interface of patient information or procedure requests and decrypting incoming messages via said network communication interface of patient information, procedure requests, or a response to said procedure request.

79. The method of claim 72 wherein said network communication interface comprises connection via an ISP.

80. The method of claim 72 further comprising evaluating said procedure requests by comparing said patient information and procedure requests to a rules based protocol located on said PED.

81. The method of claim 72 further comprising evaluating said procedure requests by comparing said patient information and procedure requests to a rules based protocol located on said server.

82. The method of claim 72 wherein entering patient information comprises patient personal information, insurance information, symptoms, diagnosis, examination information, and procedures performed.

83. The method of claim 72 wherein entering procedure requests comprises requesting a prescription.

84. The method of claim 72 wherein entering procedure requests comprises requesting lab testing.

85. The method of claim 72 wherein entering procedure requests comprises requesting a treatment procedure.

86. The method of claim 72 wherein entering procedure requests comprises requesting a diagnostic procedure.

87. The method of claim 86 wherein requesting a prescription further comprises referencing said prescription with patient information and a prescription information compendium for prescription interactions before completing prescription requests.

88. The method of claim 72 wherein said procedure requests and fulfilled in real-time.

89. The method of claim 72 wherein results of said procedure requests are updated to said PED.

90. The method of claim 73 further comprising updating said data storage medium to include medical reference guide.

91. The method of claim 73 further comprising updating said data storage medium to include prescription reference guide.

92. The method of claim 73 further comprising updating said data storage medium to include billing codes.

93. The method of claim 73 further comprising updating said data storage medium to include symptom based diagnostic information.

94. The method of claim 73 further comprising updating said data storage medium to include treatment step protocols.

95. The method of claim 73 further comprising updating said data storage medium to include a length of stay guide.

96. The method of claim 72 wherein said networked computer system further comprises a PC.

97. The method of claim 96 wherein said PC serves the network connection interface of said PED.

98. The method of claim 96 wherein said PC further comprises a physician practice management system.

99. The method of claim 98 further comprising updating said PED with information from said physician practice management system.

100. The method of claim 73 further comprising importing information from said server to said PED data storage medium.

101. The method of claim 100 wherein importing comprises parsing a text file from said server.

102. The method of claim 72 wherein said patient info or procedure request further comprises assessing a fee based at least in part on said patient info or procedure request.

103. The method of claim 72 wherein communicating via said network communication interface comprises communication via the internet.

104. The method of claim 72 wherein said server is programmed to receive and respond to communication from said PED.
